(19) United States
(12) Patent Application Publication
(10) Pub. No.: US 2007/0078581 A1
(43) Pub. Date: Apr. 5, 2007

(54) Vehicle dynamics control system adapted to the load condition of a vehicle

(76) Inventors: Gero Nenninger, Markgroeningen (DE); Matthew Nimmo, Ludwigsburg (DE); Gerald Graf, Remseck (DE); Laszlo Brooks, Korntal-Muenchingen (DE)

Correspondence Address: KENYON & KENYON LLP, ONE BROADWAY, NEW YORK, NY, 10004, US

(21) Appl. No.: 10/575,768

(22) PCT Filed: Sep. 15, 2004
(86) PCT No.: PCT/DE04/02057

§ 371 Date: Apr. 12, 2006

(30) Foreign Application Priority Data
Oct. 24, 2003 (DE) 103 49 635.1
Feb. 11, 2004 (DE) 10 2004 006 696.5

(51) Int. Cl. G06G 7/76

(52) U.S. Cl. 701/70

(57) ABSTRACT

A method for rollover stabilization of a vehicle in critical driving situations, in which a rollover stabilization algorithm intervenes in the driving operation in a critical situation, using an actuator in order to stabilize the vehicle. Different loading states of the vehicle may be taken into consideration in that the vehicle mass as well as the characteristic speed and the ratio of the contact patch forces of the wheels are ascertained, and the rollover stabilization algorithm is executed as a function of the vehicle mass and the estimated vehicle center of gravity.

### FIELD OF THE INVENTION

The present invention relates to a system and method for stabilizing a vehicle in a situation critical to rollover.

### BACKGROUND INFORMATION

Vehicles having a high center of gravity, such as minivans, SUV's (sport utility vehicles), or vans, are prone to rolling over about the longitudinal axis, in particular when cornering at a transverse acceleration that is too high. For this reason, frequently rollover stabilization systems, such as ROM (rollover mitigation) are used, with the aid of which situations critical to rollover may be recognized early and stabilizing measures are able to be triggered. Conventional driving dynamics control systems, such as ESP, having a rollover stabilization function (ROM), usually intervene in the driving operation by way of the braking system, engine management or an active steering, so as to stabilize the vehicle. A conventional vehicle dynamics control system having an ROM function is shown by way of example in FIG. 1.

FIG. 1 shows a highly simplified schematic block diagram of a conventional ROM system, which generally includes a control unit 1 having an ROM control algorithm 4,5, a sensor system 2 for detecting a driving condition critical to rollover, and an actuator 3 for executing a stabilization action. If, on account of the sensor signals of ESP sensor system 2, control unit 1 detects a situation critical to rollover, the driving dynamics control intervenes in the driving operation, for instance by operating the outer front wheel brake. Thereby the transverse acceleration and the yaw speed of the vehicle are lowered, and the vehicle is stabilized. Other systems use, for example, an active spring/damping system (normal force distribution system), the engine management system or an active steering system, in order to stabilize the vehicle.

A substantial cause for rollover of a vehicle about the longitudinal axis is, generally, too high a transverse acceleration. Therefore, modern driving dynamics control systems commonly use a variable that describes the transverse dynamics of the vehicle (which from here on will be designated as indicator variable S) in order to detect a driving situation that is critical to rollover. The indicator variable is compared to a characteristic threshold value, and a stabilization action is executed if the threshold value is exceeded. Usually, the indicator variable also determines the intensity of the stabilization action.

FIG. 2 shows the different input variables, which enter into the calculation of indicator variable S. One essential component, in this connection, is the transverse acceleration of the vehicle. Since the transverse acceleration ay follows the steering specification (setting of the steering wheel) with a phase lag, the measured value of transverse acceleration ay is usually increased as a function of the change in the steering angle, and possibly of additional influential variables P, such as, for instance, the change with time of the transverse acceleration d_{ay}dt. Consequently, the resulting so-called effective transverse acceleration, which at the same time forms the indicator variable S, is a function F of transverse acceleration a_{y}, the change in the transverse acceleration of the vehicle with respect to time d_{ay}/dt, and, if indicated, other influence variables P.

As may be seen in FIG. 2, input variables a_{y},d_{ay}/dt, P are linked according to a function 4, and from this, indicator variable S is calculated. Indicator variable S thus obtained, is finally supplied to control algorithm 5, and it determines the duration and the magnitude of the control intervention.

Besides the constructive properties of the vehicle, the rollover behavior of a vehicle is generally a function of the loading. With increasing loading, the rollover inclination of the vehicle grows, as a rule, and vice versa. In addition, constructive features, such as the suspension, may change depending on age, and consequently may affect the rollover tendency of the vehicle. Loading and mechanical condition are usually not explicitly taken into consideration in the conventional driving dynamics controls having a rollover stabilization function ROM.

Therefore, conventional rollover stabilization functions ROM are usually very sensitive, that is, attuned to high loading conditions and soft suspension, in order to ensure a safe driving behavior, especially in vehicles having great loading variation, such as SUV's or small delivery trucks. This has the result that, at normal loading, a stabilization intervention is already triggered at very low transverse acceleration values. This means that, at normal or low loading, the rollover stabilization interventions may take place too early or too energetically.

### SUMMARY

It is an object of the present invention to create a method for rollover stabilization of vehicles, as well as a corresponding driving dynamics control system with which the loading state of a vehicle, and consequently its rollover tendency, may be estimated in a simple way and may be taken into consideration within the scope of a rollover stabilization algorithm.

One aspect of the present invention is to determine the current rollover tendency of the vehicle, by ascertaining at least the mass of the vehicle (or the payload), and to adjust the control behavior of the rollover stabilization algorithm to the current vehicle mass. By doing this, the rollover stabilization algorithm may be adapted to the respective loading state or the respective rollover tendency of the vehicle.

The vehicle mass may, for example, be determined using a sensor system, such as a wheel force sensor system for determining the normal forces (center of tire contact forces) or a sensor system for measuring the compression travel. The vehicle mass may also optionally be estimated by the evaluation of the driving behavior, such as the acceleration behavior or braking behavior of the vehicle, by setting up a forces balance or torque balance. Various estimating methods for doing this are conventional. Estimating the vehicle mass has the advantage that, besides the ESP sensor system that is present anyhow, no additional sensor system has to be provided. In order to estimate the vehicle mass, for example, wheel rotary speed sensors and the engine torque signal are evaluated, and optionally a transverse acceleration sensor and a yaw rate sensor, a steering angle sensor and/or a longitudinal acceleration sensor.

The information obtained (whether measured or estimated) concerning the vehicle mass may finally be taken into consideration by the driving dynamics control.

Besides by the height (mass) of the payload, the rollover tendency of a vehicle is influenced also by the position or the distribution of the payload. It is therefore provided, preferably to ascertain information also on the position of the payload, in particular the height of the center of gravity (of the payload or of the vehicle), and to take this into consideration in the rollover stabilization.

According to a first specific example embodiment of the present invention, the vehicle's center of gravity (this includes also information from which the vehicle's center of gravity may be derived) is estimated by evaluating a characteristic speed v_{ch} of the vehicle. The characteristic speed is a parameter in the known “Ackermann equation”, and it describes the characteristic steering behavior of a vehicle. In the usual suspension design, it is accepted that, when the center of gravity is shifted upwards, a vehicle demonstrates a more strongly understeering driving behavior, and consequently has a lower characteristic speed, and vice versa. When, on the other hand, there is a shifting of the center of gravity to the rear (at constant mass and constant height of the center of gravity), the vehicle demonstrates a less understeered vehicle behavior and consequently a greater characteristic speed v_{ch}, and vice versa. In conventional driving dynamics controls, characteristic speed v_{ch} is itself, in turn, estimated. From the deviation of the estimated characteristic speed v_{chEst} from the nominal estimated speed v_{chNom}, thus, at least qualitatively information may be gained on the position of the load (height of the center of gravity and/or position in the longitudinal direction of the vehicle).

According to a second specific example embodiment of the present invention, the position of the vehicle's center of gravity, and especially the height of the center of gravity may be estimated from an examination of the contact patch forces of the wheels at an inside and an outside wheel during cornering. At a high mass center of gravity, the contact patch force at the outer wheel is comparatively higher than for a low mass center of gravity (at equal mass of the payload) at the same transverse acceleration. Because of the increased tendency of the vehicle to roll over, the outer wheels are more greatly unloaded at high mass center of gravity. From the ratio of the contact patch forces F_{N1}/F_{Nr} of an inner and an outer wheel, one may thus qualitatively estimate the height of the vehicle's center of gravity.

Contact patch forces F_{N} may, in turn, be measured either using a suitable sensor system or estimated from the ratio of the tire slips of the individual wheels. The wheel slips, in turn, may be calculated using the ESP sensor system that is present anyway, especially the rotary speed sensors.

According to a third specific example embodiment of the present invention, the estimating methods described in specific embodiments 1 and 2 may be combined, in order to achieve a qualitative improvement and a greater availability of the estimated height of the center of gravity.

The ascertained information according to the present invention on the rollover inclination of the vehicle (that is, the vehicle mass and, perhaps additionally the estimated position of the center of gravity) may, according to a first specific embodiment, flow into the calculation of indicator variable S, and may consequently influence the triggering point in time or the deactivating point in time of the control system.

As an option, the information regarding the rollover tendency may also enter into the rollover stabilization algorithm itself and influence a characteristic property of the algorithm, such as a control threshold value (a_{y,krit}) a control deviation, e.g., for a wheel slip, or a controlled variable, such as the braking torque or the engine torque. The characteristic property of the algorithm is thus a function of the rollover tendency of the vehicle, that is, of the vehicle mass and, if necessary, additionally, of the position of the vehicle's center of gravity. Consequently, in the case of a high rollover tendency, i.e., a large vehicle mass or a high center of gravity, a stabilization intervention may be initiated earlier or carried out to a greater degree than in the case of a lower rollover tendency.

A vehicle dynamics control system, having a rollover stabilization function, preferably includes a device (sensor system or estimation algorithm), using which one may calculate or estimate the vehicle mass and/or the position of the vehicle's center of gravity, and a control unit in which the rollover stabilization algorithm is filed, the rollover stabilization algorithm being implemented in such a way that the control behavior of the algorithm is a function of the vehicle mass and/or the position of the vehicle's center of gravity.

### BRIEF DESCRIPTION OF THE DRAWINGS

In the following, the present invention is explained in detail by way of example, with reference to the figures.

FIG. 1 shows a schematic block diagram of a conventional rollover stabilization system.

FIG. 2 shows a schematic representation of a function for forming an indicator variable S.

FIG. 3 shows a block diagram of a rollover stabilization system according to a specific example embodiment of the present invention.

FIG. 4 shows the slip and contact patch force ratios in straight-ahead driving and curve driving.

FIG. 5 shows the dependence of the critical transverse acceleration on the height of the center of gravity.

### DETAILED DESCRIPTION OF EXAMPLE EMBODIMENTS

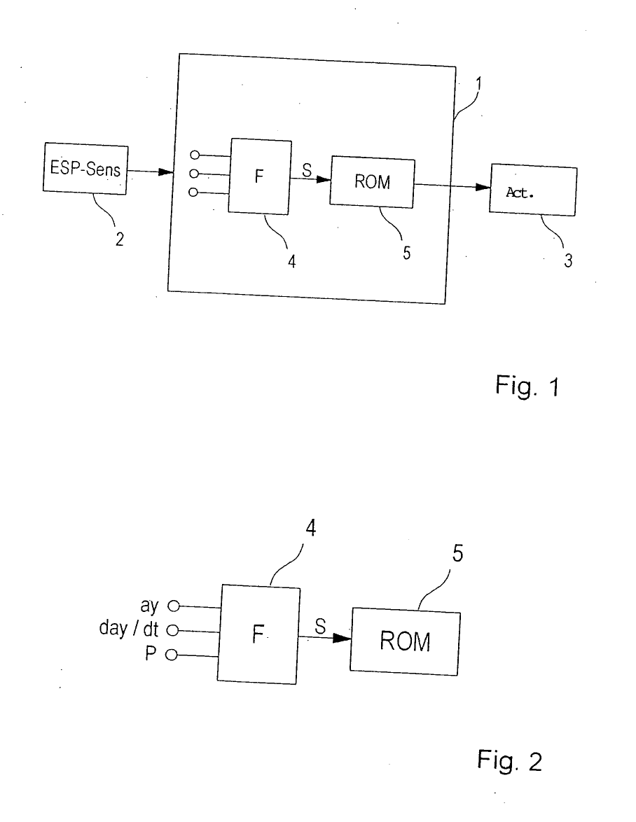

Reference is made to the introductory part of the specification regarding the clarification of FIGS. 1 and 2.

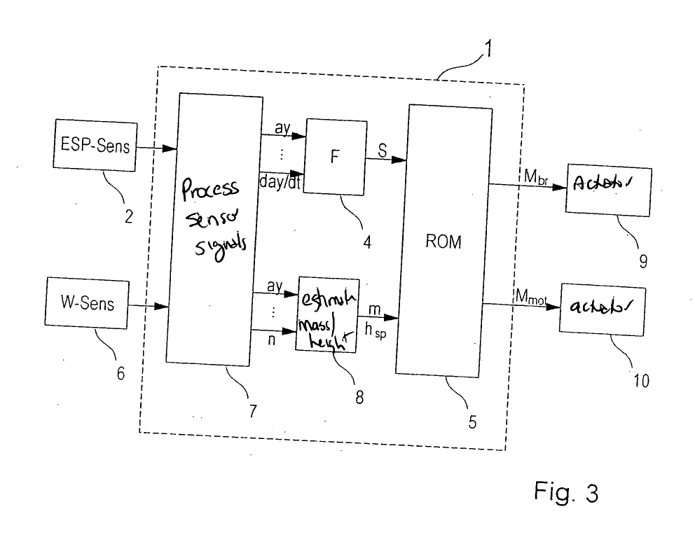

FIG. 3 shows a schematic block diagram of a rollover-stabilization system. The system includes a control unit 1 having a rollover-stabilization algorithm ROM (rollover mitigation), a sensor system 2, for measuring driving-condition variables, and various actuators 9, 10, with the aid of which the required stabilization interventions are implemented. Blocks 4, 7, 8 are implemented in the form of software and are used for processing the sensor signals (block 7), estimating the rollover tendency (by estimating the vehicle mass and the position of the center of gravity) of the vehicle (block 8), and generating an indicator variable S (block 4).

In this example, the rollover stabilization system utilizes exclusively ESP sensor system 2 that is already present, both for detecting a rollover-critical driving situation and for estimating vehicle mass m and the height of the center of gravity hₛₚ. (Optionally, there could also be provided an additional sensor system by which the variables sought (m, hₛₚ) may be measured.

ESP sensor system 2 includes, in particular, wheel speed sensors, a steering angle sensor, a transverse acceleration sensor, a yaw rate sensor, etc. The sensor signals are processed in block 7, and, in the process, they are particularly rendered free of interference and are filtered. A plausibility check of the sensor signals is preferably carried out, as well.

Selected signals, namely transverse acceleration ay, gradient d_{ay}/dt and possibly additional variables P flow into block 4. In it, as was described above with respect to FIG. 2, an indicator variable S is calculated, which controls the release or the deactivation of stabilization interventions. In this context, indicator variable S also determines the intensity of the stabilization interventions.

In order to be able to take into consideration load conditions of the vehicle during the rollover stabilization, a block 8 is additionally provided. Block 8 includes algorithms by which vehicle mass m (or information from which the vehicle mass is able to be derived) and the height of the vehicle's center gravity hₛₚ may be estimated. The sought-after estimating variables m, hₛₚ are, in particular, ascertained from transverse acceleration a_{y}, wheel rotary speeds n, the engine torque and the yaw rate.

Estimating values m,hₛₚ are finally supplied to the rollover stabilization algorithm, and are used to change a characteristic property of the algorithm, such as a control threshold value (a_{y,krit}), a control deviation, e.g., for a wheel slip, or a controlled variable, such as the braking torque or the engine torque. Optionally, indicator variable S could also be modified. The characteristic property of the algorithm is thus a function of vehicle mass m and/or the position of the vehicle's center of gravity hₛₚ. Consequently, in the case of a high rollover tendency, i.e., a large vehicle mass m or a high center of gravity hₛₚ, a stabilization intervention may be initiated earlier or carried out to a greater degree than in the case of a lower rollover tendency.

Vehicle mass m is ascertained, for example, in response to a braking procedure or an acceleration procedure, by setting up a balance of forces of the forces acting on the vehicle, taking into consideration the acceleration and deceleration of the vehicle.

The position of the center of gravity in the z direction (the vertical direction) and also in the vehicle's longitudinal direction (forwards, backwards) may be estimated, for example, by the characteristic speed v_{ch} of the vehicle. The characteristic speed v_{ch} is a parameter which describes the self-steering properties of the vehicle. According to the Ackermann equation, which calculates the yaw rate dψ/dt of a vehicle according to the so-called “single-track model”,

$$ⅆ ψ / ⅆ t = \frac{{v}_{x} \cdot {δ}_{R}}{l \cdot ( 1 + {v}_{x}^{2} : {v}_{ch}^{2} )}$$

holds, where vₓ is the vehicle speed in the longitudinal direction, δ_{R} is the steering angle and v_{ch} is the characteristic speed.

In the usual suspension design, it is accepted that, when the center of gravity is shifted upwards, a vehicle demonstrates a more strongly understeering driving behavior, and consequently has a lower characteristic speed v_{ch}, and vice versa. When, on the other hand, there is a shifting of the center of gravity to the rear (at constant mass and constant height of the center of gravity), the vehicle demonstrates a less understeered vehicle behavior and consequently a greater characteristic speed v_{ch}, and vice versa.

By estimating the characteristic speed v_{ch} from the above relationship, one may ascertain at least qualitative information about the position of the vehicle's center of gravity and the distribution of the payload in the vehicle. Depending on whether the estimated characteristic speed is greater or less than a nominal value v_{ch,nominal} (e.g., without payload), a statement may consequently be made about the position of the mass center of gravity. The following table gives a summary of the qualitative statements that may be made by estimating of characteristic speed v_{ch}. In this context, the first table applies for a small payload and the second table for a large payload.

| small payload | payload centrical | payload in rear |
|---|---|---|
| high payload center | V_{ch} < V_{ch}_{_{—}}ₙₒₘᵢₙₐₗ | V_{ch} < V_{ch}_{_{—}}ₙₒₘᵢₙₐₗ |
| of gravity | | |
| low payload center | V_{ch} ≈ V_{ch}_{_{—}}ₙₒₘᵢₙₐₗ | V_{ch} > V_{ch}_{_{—}}ₙₒₘᵢₙₐₗ |
| of gravity | | |

| large payload | payload centrical | payload in rear |
|---|---|---|
| high payload center | V_{ch} << V_{_{ch}}_ₙₒₘᵢₙₐₗ | V_{ch} < V_{ch}_{_{—}}ₙₒₘᵢₙₐₗ |
| of gravity | | |
| low payload center | V_{ch} ≈ V_{ch}_{_{—}}ₙₒₘᵢₙₐₗ | V_{ch} >> V_{ch}_{_{—}}ₙₒₘᵢₙₐₗ |
| of gravity | | |

Optionally, the height of the center of gravity may also be estimated from the contact patch forces of the wheels at the inner and outer wheels during cornering. At a high mass center of gravity, (i.e., without payload) the contact patch force at the outer wheel is comparatively higher than for a low mass center of gravity at the same transverse acceleration. Because of the increased tendency of the vehicle to roll over, the inner wheels are more greatly unloaded at high mass center of gravity. From the ratio of the contact patch forces F_{N1}/F_{Nr} of an inner and an outer wheel, one may thus qualitatively estimate the height of the vehicle's center of gravity.

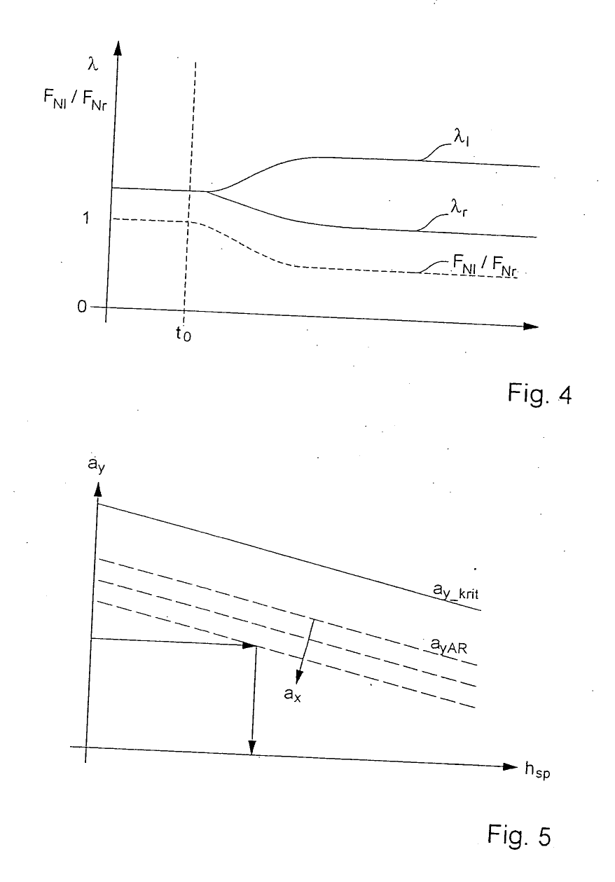

FIG. 4 shows the curve of the contact patch force ratio F_{N1}/F_{Nr} and of wheel slip λ at a left and a right wheel (subscripts l,r; here F_{Bl}=F_{Br}). Up to point t₀, the vehicle travels straight ahead and then into a left curve. Wheel slip λ₁ (driving slip or braking slip) at the inner left wheel increases in this context, and the one at the right wheel decreases. The ratio of contact patch force at the wheel F_{Nl}/F_{Nr} decreases correspondingly, as may be seen in the figure. The height of the center of gravity may, in turn, be estimated by the evaluation of the ratio of the contact patch forces of the wheels as a function of the lateral acceleration.

FIG. 5 shows the dependence of the lateral acceleration a_{yAR} (at which the inner rear wheel lifts off from the ground) of the center of gravity height hₛₚ. (At the critical lateral acceleration a_{y}_{_{—}}ₖᵣᵢₜ, the vehicle rolls over). As will be seen, lateral acceleration a_{yAR} decreases with increasing height of the center of gravity hₛₚ. By increased braking (see deceleration aₓ) it decreases further. The lifting off of the rear wheel may consequently be detected, and the height of the center of gravity may be estimated.

By a combination of the two methods of determining the height of the center of gravity, a qualitative improvement and a greater availability may be achieved of the estimated height of the center of gravity.

1-13. (canceled)

14. A method for rollover stabilization of a vehicle in a critical driving situation, comprising:
ascertaining a mass of the vehicle; and
executing a rollover stabilization algorithm as a function of the mass of the vehicle, the rollover stabilization algorithm intervening in a driver operation in a critical situation using an actuator in order to stabilize the vehicle.

15. The method as recited in claim 14, wherein the mass of the vehicle is estimated using an algorithm.

16. The method as recited in claim 14, further comprising:
estimating information on a center of gravity of the vehicle, wherein the rollover stabilization algorithm is executed as a function of the vehicle mass and the information on the center of gravity of the vehicle.

17. The method as recited in claim 16, wherein the information on the center of gravity of the vehicle is derived from an estimated characteristic speed.

18. The method as recited in claim 16, wherein the information on the center of gravity of the vehicle is ascertained from a ratio of contact patch forces of opposite wheels during cornering.

19. The method as recited in claim 17, wherein the information on the center of gravity of the vehicle is ascertained from the estimated characteristic speed and from a ratio of the contact patch forces of opposite wheels during cornering.

20. The method as recited in claim 16, wherein one of an indicator variable or a characteristic property of the rollover stabilization algorithm is determined as a function of one of the mass of the vehicle or the mass of the vehicle and information on the center of gravity of the vehicle, the release of deactivation of the stabilization intervention being a function of the indicator variable.

21. The method as recited in claim 16, wherein one of a control threshold value, a system deviation or a controlled variable of the rollover stabilization algorithm is determined as a function of one of the mass of the vehicle or the mass of the vehicle and the information on the center of gravity of the vehicle.

22. A vehicle dynamics control system for rollover stabilization of a vehicle in a critical driving situation, comprising:
a control unit in which a rollover stabilization algorithm is stored;
a sensor system to record current actual values of driving state variables; and
an actuator to carry out a stabilization intervention when a rollover-critical situation is detected;
wherein using the sensor system, information is ascertained on a mass of the vehicle and the rollover stabilization algorithm is configured so that a behavior of the control system is a function of the mass of the vehicle.

23. The vehicle dynamics control system as recited in claim 22, wherein the control unit includes an algorithm for estimating the mass of the vehicle.

24. The vehicle dynamics control system as recited in claim 22, wherein the control unit includes an algorithm for estimating information on a center of gravity of the vehicle, the estimated information being taken into consideration together with the mass of the vehicle during a rollover stabilization.

25. The vehicle-dynamics control system as recited in claim 24, wherein the information on the center of gravity of the vehicle is derived from an estimated characteristic speed.

26. The vehicle dynamics control system as recited in claim 22, wherein a sensor system includes sensors using a ratio of contact patch forces of opposite wheels is able to be ascertained.
